(19) United States
(12) Patent Application Publication
(10) Pub. No.: US 2011/0261187 A1
(43) Pub. Date: Oct. 27, 2011

(54) Extracting and Mapping Three Dimensional Features from Geo-Referenced Images

(76) Inventors: Peng Wang, Beijing (CN); Tao Wang, Beijing (CN); Dayong Ding, Beijing (CN); Yimin Zhang, Beijing (CN)

(21) Appl. No.: 13/000,099

(22) PCT Filed: Feb. 1, 2010
(86) PCT No.: PCT/CN10/00132

§ 371 Date: Jul. 8, 2011

(51) Int. Cl. H04N 7/18; G06T 15/00

(52) U.S. Cl. 348/113; 345/419; 348/E07.085

(57) ABSTRACT

Mobile Internet devices may be used to generate Mirror World depictions. The mobile Internet devices may use inertial navigation system sensor data, combined with camera images, to develop three dimensional models. The con of an input geometric model may be aligned with edge features of the input camera images instead of using point features of images or laser scan data.

### BACKGROUND

This relates generally to the updating and enhancing of three dimensional models of physical objects.

A Mirror World is a virtual space that models a physical space. Applications, such as Second Life, Google Earth, and Virtual Earth, provide platforms upon which virtual cities may be created. These virtual cities are part of an effort to create a Mirror World. Users of programs, such as Google Earth, are able to create Mirror Worlds by inputting images and constructing three dimensional models that can be shared from anywhere. However, generally, to create and share such models, the user must have a high end computation and communication capacity.

### BRIEF DESCRIPTION OF THE DRAWINGS

FIG. 1 is a schematic depiction of one embodiment of the present invention;

FIG. 2 is a schematic depiction of the sensor components shown in FIG. 1 in accordance with one embodiment;

FIG. 3 is a schematic depiction of an algorithmic component shown in FIG. 1 in accordance with one embodiment;

FIG. 4 is a schematic depiction of additional algorithmic components also shown in FIG. 1 in accordance with one embodiment;

FIG. 5 is a schematic depiction of additional algorithmic components shown in FIG. 1 in accordance with one embodiment; and

FIG. 6 is a flow chart in accordance with one embodiment.

### DETAILED DESCRIPTION

In accordance with some embodiments, virtual cities or Mirror Worlds may be authored using mobile Internet devices instead of high end computational systems with high end communication capacities. A mobile Internet device is any device that works through a wireless connection and connects to the Internet. Examples of mobile Internet devices include laptop computers, tablet computers, cellular telephones, handheld computers, and electronic games, to mention a few examples.

In accordance with some embodiments, non-expert users can enhance the visual appearance of three dimensional models in a connected visual computing environment such as Google Earth or Virtual Earth.

The problem of extracting and modeling three dimensional features from geo-referenced images may be formulated as a model-based three dimensional tracking problem. A coarse wire frame model gives the contours and basic geometry information of a target building. Dynamic texture mapping may then be automated to create photo-realistic models in some embodiments.

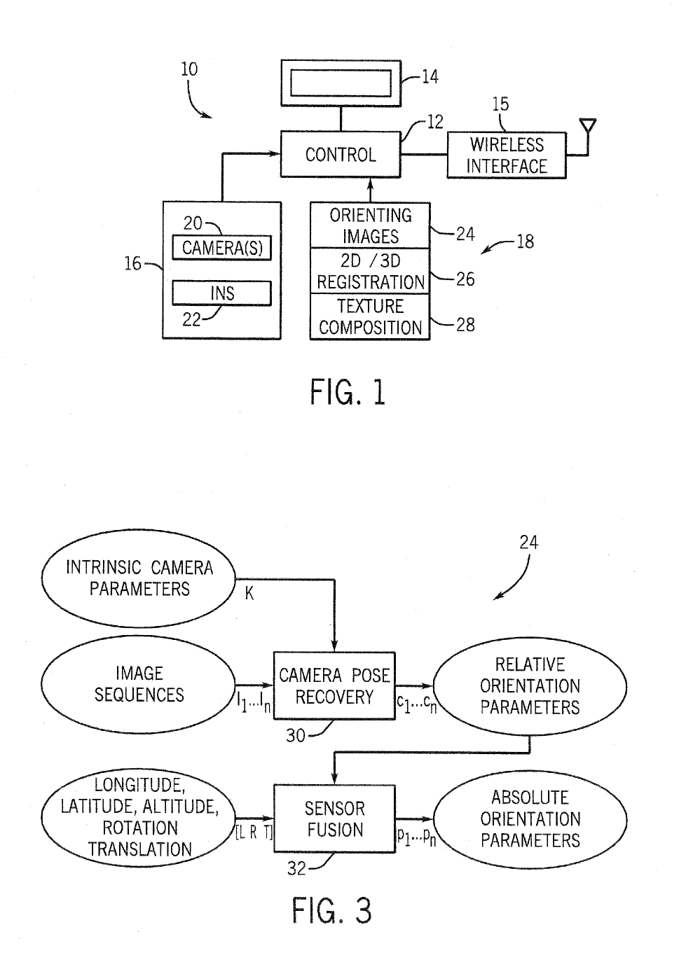

Referring to FIG. 1, a mobile Internet device 10 may include a control 12, which may be one or more processors or controllers. The control 12 may be coupled to a display 14 and a wireless interface 15, which allows wireless communications via radio frequency or light signals. In one embodiment, the wireless interface may be a cellular telephone interface and, in other embodiments, it may be a WiMAX interface. (See IEEE std. 802.16-2004 IEEE Standard for Local and Metropolitan Area Networks, Part 16: Interface for Fixed Broadboard Wireless Access Systems, IEEE New York, N.Y., 10016).

Also coupled to the control 12 is a set of sensors 16. The sensors may include one or more high resolution cameras 20 in one embodiment. The sensors may also include inertial navigation system (INS) sensors 22. These may include global positioning systems, wireless, inertial measurement unit (IMU), and ultrasonic sensors. An inertial navigation system sensor uses a computer, motion sensors, such as accelerometers, and rotation sensors, such as gyroscopes, to calculate via dead reckoning the position, orientation, and velocity of a moving object without the need for external references. In this case, the moving object may be the mobile Internet device 10. The cameras 20 may be used to take pictures of an object to be modeled from different orientations. These orientations and positions may be recorded by the inertial navigation system 22.

The mobile Internet device 10 may also include a storage 18 that stores algorithmic components, including image orientation module 24, 2D/3D registration module 26, and texture components 26. In some embodiments, at least one high resolution camera is used or two lower resolution cameras for front and back views, respectively, if a high resolution camera is not available. The orientation sensor may be a gyroscope, accelerometer, or magnetometer, as examples. Image orientation may be achieved by camera calibration, motion sensor fusion, and correspondence alignment. The two dimensional and three dimensional registration may be by means of a model-based tracking and mapping, and fiducial based rectification. The texture composition may be by means of blending different color images to e three dimensional geometric surface.

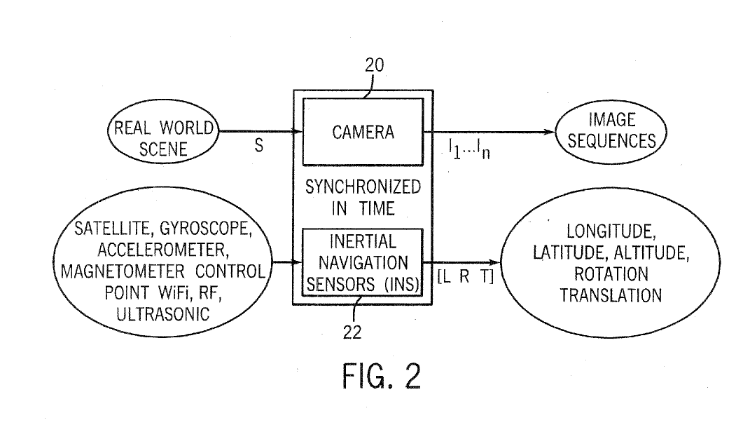

Referring to FIG. 2, the sensor components 22 in the form of inertial navigation sensor receive, as inputs, one or more of satellite, gyroscope, accelerometer, magnetometer, control point WiFi, radio frequency (RF), or ultrasonic signals that give position and orientation information about the mobile Internet device 10. The camera(s) 20 record(s) a real world scene S. The camera 20 and inertial navigation system sensors are fixed together and are temporarily synchronized when capturing image sequences I₁ . . . Iₙ), location (L=longitude, latitude, and altitude), rotation (R=R₁, R₂, R₃) matrix and translation T data.

Referring to FIG. 3, the algorithmic component 24 is used for orienting the images. It includes a camera pose recovery module 30 that extracts relative orientation parameters c₁ . . . cₙ and sensor fusion module 32 that computes absolute orientation parameters p₁ . . . pₙ. The input intrinsic camera parameters K are a 3×3 matrix that depends on the scale factor in the u and v coordinate directions, the principal point, and the skew. The sensor fusion algorithms 32 may use a Kalman filter or Bayesian networks, for example.

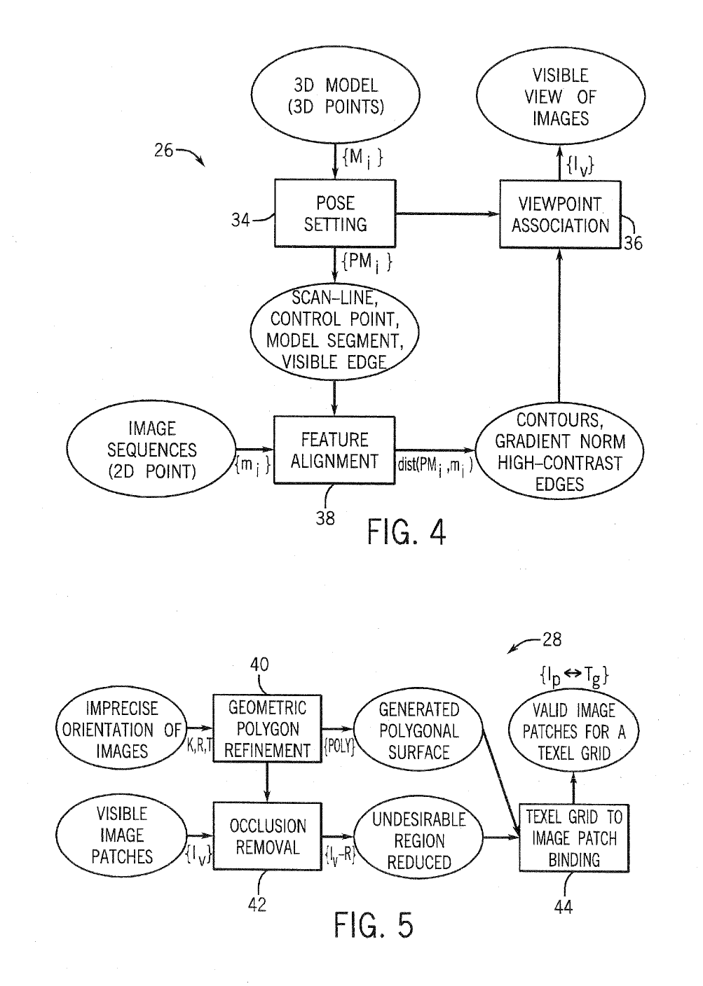

Referring next to FIG. 4, the 2D/3D registration module 26, in turn, includes a plurality of sub-modules. In one embodiment, a rough three dimensional frame model may come in the form of a set of control points Mᵢ. Another input may be user captured image sequences using the camera 20, containing the projected control points mᵢ. The control points may be sampled along the three dimensional model edges and in areas of rapid albedo change. Thus, rather than using points, edges may be used.

The predicted pose PM ᵢ indicates which control points are visible and what their new location should be. And the new pose is updated by searching correspondence distance (dist (PMᵢ, mᵢ) in the horizontal, vertical, or diagonal direction, closest to the model edge normal. With enough control points, pose parameters can be optimized by solving a least squares problem in some embodiments.

Thus, the pose setting module 34 receives the wire frame model input and outputs scan line, control point, model segments, and visible edges. This information is then used in the feature alignment sub-module 38 to combine the pose setting with the image sequences from the camera to output contours, gradient normals, and high contrast edges in some embodiments. This may be used in the viewpoint association sub-module 36 to produce a visible view of images, indicated as Iᵥ.

Turning next to FIG. 5 and, particularly, the texture composition module 28, the corresponding image coordinates are calculated for each vertex of a triangle on the 3D surface, knowing the parameters of the interior and exterior orientation of the images (K, R, T). Geometric corrections are applied at the sub-module 40 to remove imprecise image registration or errors in the mesh generation (Poly). Extraneous static or moving objects, such as pedestrians, cars, monuments, or trees, imaged in front of the objects to be modeled may be removed in the occlusion removal stage 42 (Iᵥ-R). The use of different images acquired from different positions or under different lighting conditions may result in radiometric image-distortion. For each texel grid (T_{g}), the subset of valid image patches (Iₚ) that contain a valid projection is bound. Thus, the sub-module 44 binds the texel grid to the image patch to produce the valid image patches for a texel grid.

Once a real world scene is captured by the camera and sensors, the image sequences in raw data may be synchronized in time. The Mirror World representation may be updated after implementing the algorithmic components of orienting images using camera pose recovery and sensor function, 2D/3D registration using pose prediction, distance measurement and viewpoint association, and texture composition using geometric polygon refinement, occlusion removal, and texture grid image patch binding, as already described.

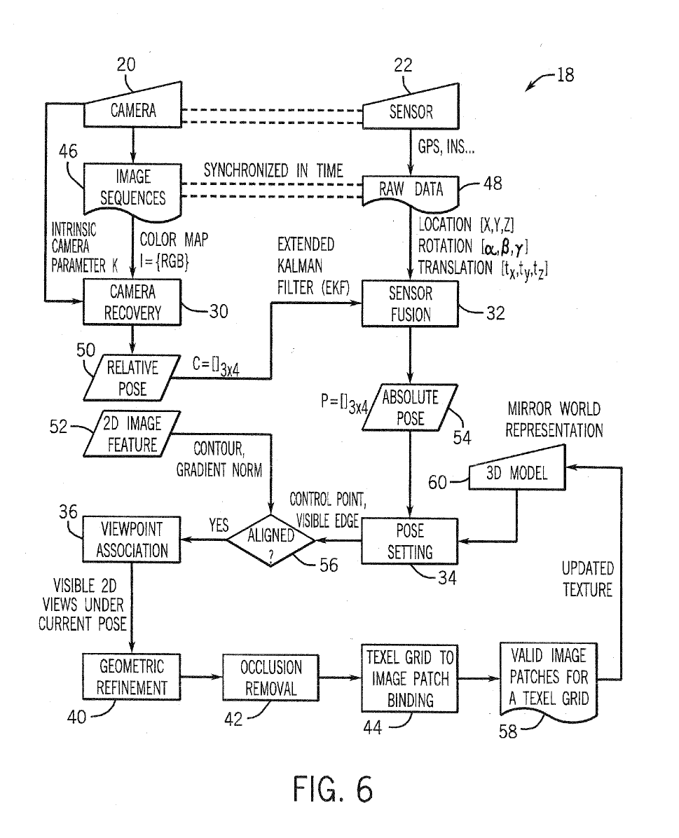

Thus, referring to FIG. 6, the real world scene is captured by the camera 20, together with sensor readings 22, resulting in image sequences 46 and raw data 48. The image sequences provide a color map to the camera recovery module 30, which also receives intrinsic camera parameter K from the camera 20. The camera recovery module 30 produces the relative pose 50 and two dimensional image features 52. The two dimensional image features are checked at 56 to determine whether the contour and gradient norms are aligned. If so, a viewpoint association module 36 passes visible two dimensional views under the current pose to a geometric refinement module 40. Thereafter, occlusion removal may be undertaken at 42. Then, the texel grid to image patch binding occurs at 44. Next, valid image patches for a texel grid 58 may be used to update the texture in the three dimensional model 60.

The relative pose 50 may be processed using an appropriate sensor fusion technique, such as an Extended Kalman filter (EKE) in the sensor fusion module 32. The sensor fusion module 32 fuses the relative pose 50 and the raw data, including location, rotation, and translation information to produce an absolute pose 54. The absolute pose 54 is passed to the pose setting 34 that receives feedback from the three dimensional model 60. The pose setting 34 is then compared at 66 to the two dimensional image feature 52 to determine if alignment occurs. In some embodiments, this may be done using a visual edge as a control point, rather than a point, as may be done conventionally.

In some embodiments, the present invention may be implemented in hardware, software, or firmware. In software embodiments, a sequence of instructions may be stored on a computer readable medium, such as the storage 18, for execution by a suitable control that may be a processor or controller, such as the control 12. In such case, instructions, such as those set forth in modules 24, 26, and 28 in FIG. 1 and in FIGS. 2-6, may be stored on a computer readable medium, such as a storage 18, for execution by a processor, such as the control 12.

In some embodiments, a Virtual City may be created using mobile Internet devices by non-expert users. A hybrid visual and sensor fusion for dynamic texture update and enhancement uses edge features for alignment and improves accuracy and processing time of camera pose recovery by taking advantage of inertial navigation system sensors in some embodiments.

References throughout this specification to “one embodiment” or “an embodiment” mean that a particular feature, structure, or characteristic described in connection with the embodiment is included in at least, one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
mapping three dimensional features from geo-referenced images by aligning an input geometric model contour with an edge feature of input camera images.

2. The method of claim 1 including mapping the three dimensional features using a mobile Internet device.

3. The method of claim 1 including using inertial navigation system sensors for camera pose recovery.

4. The method of claim 1 including creating a Mirror World.

5. The method of claim 1 including combining inertial navigation system sensor data and camera images for texture mapping.

6. The method of claim 1 including performing camera recovery using an intrinsic camera parameter.

7. A computer readable medium storing instructions executed by a computer to align an input geometrical model contour with an edge feature of input camera images to form a geo-referenced three dimensional representation.

8. The medium of claim 7 further storing instructions to align the model with the edge feature using a mobile Internet device.

9. The medium of claim 7 further storing instructions to use inertial navigation system sensors for camera pose recovery.

10. The medium of claim 7 further storing instructions to create a Mirror World.

11. The medium of claim 7 further storing instructions to combine inertial navigation system sensors data and camera images for texture mapping.

12. The medium of claim 7 further storing instructions to perform camera recovery using an intrinsic camera parameter.

13. An apparatus comprising:
a control;
a camera coupled to said control;
an inertial navigation system sensor coupled to said control; and
wherein said control to align an input geometric model contour with an edge feature of images from said camera.

14. The apparatus of claim 13 wherein said apparatus is a mobile Internet device.

15. The apparatus of claim 13 wherein said apparatus is a mobile wireless device.

16. The apparatus of claim 13 to create a Mirror World.

17. The apparatus of claim 13, said control to combine inertial navigation system sensor data and camera images for texture mapping.

18. The apparatus of claim 13 including a sensor fusion to fuse relative orientation parameters based on camera image sequences with inertial navigation system sensor inputs.

19. The apparatus of claim 13 including. a global positioning-system receiver.

20. The apparatus of claim 13 including an accelerometer.
